(19) United States
(12) Patent Application Publication
(10) Pub. No.: US 2013/0238566 A1
(43) Pub. Date: Sep. 12, 2013

(54) STORAGE DEVICE, HOST DEVICE, AND STORAGE SYSTEM

(71) Applicant: PANASONIC CORPORATION, Osaka (JP)

(72) Inventor: Yutaka NAKAMURA, Kyoto (JP)

(73) Assignee: PANASONIC CORPORATION, Osaka (JP)

(21) Appl. No.: 13/785,449

(22) Filed: Mar. 5, 2013

(30) Foreign Application Priority Data
Mar. 9, 2012 (JP) 2012-052657
Jan. 28, 2013 (JP) 2013-013491

(51) Int. Cl. G06F 17/30

(52) U.S. Cl. CPC G06F 17/30303
USPC 707/690

(57) ABSTRACT

A storage device includes a first storage area in which data can be read out and rewritten and file data is stored, a second storage area in which data can be read out and appended to an unwritten area and a first calculated value for detecting falsification which is calculated from the file data, and a controller that performs access control on the first storage area and the second storage area. The controller includes a frontend unit that receives a command from an external host device and accesses the first storage area and the second storage area, and a falsification detection notification unit that determines, without reading out the first calculated value to the host device, whether the first calculated value matches a second calculated value for detecting falsification which is calculated from the file data and notifies the host device of the determination result.

### BACKGROUND

1. Technical Field

The present disclosure relates to a storage device having a function of determining whether stored file data, for example, is falsified or not, a host device for accessing the storage device, and a storage system having the storage device and the host device.

2. Related Art

In conventional photography using a film-based camera, the image is directly recorded in a silver film. Therefore, even if the image is modified for falsification, the silver film bears marks of the falsification, from which the falsification can be easily recognized. However, in the case of a digital still camera (hereinafter, referred to as “DSC”), a file containing image data and the like is usually stored in such a rewritable medium as a flash memory card.

As one of the features, the DSC enables a photographer to selectively erase an image file which the photographer decides is unnecessary even after taking the photographs. The DSC also enables a photographer to store image files in another medium for archive and erase all the photograph files from the flash memory card to reuse it as a new flash memory card. For that purpose, the flash memory card has a control function of rewriting files stored in the flash memory. However, that function also enables one to replace a image file stored in a flash memory card with the very photograph file falsified in such a manner as retouching of the file or partial modification of the recording date, the accompanying photographing configuration information, or the location information. In that case, unless the form of the file bears the marks of the rewriting, the falsification is hardly found.

Therefore, the above described problem becomes severe in the case where it is desired to use the images taken by using the DSC as a kind of legal evidence. To address that problem, it may be considered to use a memory card or the like which is made of, for example, a one time program memory (hereinafter, referred to as “OTP”) instead of a flash memory to prevent the stored data from being rewritten. Alternatively, even though a flash memory is still contained, it may also be considered to use a memory card or the like the specification of the backend unit of which is disabled to control rewriting of the flash memory to address that problem, otherwise the backend unit would control the flash memory. Prior art document information related to the present disclosure includes JP 2009-526333 A.

The approach of using a memory card made of an OTP to compensate for such a disadvantage of the flash memory card as having difficulty in detecting falsification with data as described above is still disadvantageous in that the memory card can be hardly provided with the capacity as large as that of the memory card containing a flash memory, and as a result, the number of images to be photographed is limited. Also, the approach of using a memory card (even though it contains a flash memory) the specification of which is changed to have a special control to disable rewriting has a risk of such falsification as rewriting of firmware in the controller or direct rewriting of the data by direct access to the flash memory. In addition, both of these kinds of memory card impair one of the intrinsic advantages of digitization, the readiness for erasing unnecessary data to enable retaking.

Therefore, the present disclosure provides a storage device, a host device, and a storage system having the storage device and the host device, capable of safely and easily detecting falsification without impairing the intrinsic advantage of digitization.

### SUMMARY

The disclosure below proposes a storage device, a host device, and a storage system capable of detecting presence or absence of falsification, instead of preventing falsification with a stored file itself, by recording data for detecting presence or absence of falsification with an unrewritable memory different from a flash memory which stores image data. Further, the above described storage device and the others notify presence or absence of falsification by comparing respective data calculated from the stored file.

According to an aspect, a storage device includes a first storage area in which data can be read out and rewritten and file data is stored, a second storage area in which data can be read out and appended to an unwritten area and a first calculated value for detecting falsification which is calculated from the file data, and a controller that performs access control on the first storage area and the second storage area, wherein the controller includes a frontend unit that receives a command from an external host device and accesses the first storage area and the second storage area, and a falsification detection notification unit that determines, without reading out the first calculated value to the host device, whether the first calculated value matches with a second calculated value for detecting falsification which is calculated from the file data and notifies the host device of the determination result.

The storage device and the others of the present disclosure enable safe and easy detection of falsification without impairing the intrinsic advantage of digitization, i.e., advantage of being able to retake.

### BRIEF DESCRIPTION OF DRAWINGS

FIG. 1 is a block diagram illustrating an exemplary configuration of a memory card according to a first embodiment;

FIG. 2 is a block diagram illustrating an exemplary configuration of a DSC according to the first embodiment;

FIG. 3 is a block diagram illustrating an exemplary configuration of a read-out device according to the first embodiment;

FIG. 4 is a flow chart describing a falsification check operation according to the first embodiment;

FIG. 5 is a table showing an exemplary format of information stored in a second partition according to the first embodiment;

FIG. 6 is a block diagram illustrating an exemplary configuration of a memory card according to a second embodiment;

FIG. 7 is a block diagram illustrating an exemplary configuration of a memory card according to a third embodiment;

FIG. 7A is a block diagram illustrating an exemplary configuration of a DSC dedicated for capturing image according to the third embodiment;

FIG. 8 is a timing chart showing a data writing sequence according to the third embodiment;

FIG. 9 is a block diagram illustrating an exemplary configuration of a memory card according to a fourth embodiment;

FIG. 10 is a block diagram illustrating the second partition according to a fifth embodiment;

FIG. 11 is an equivalent circuit diagram illustrating exemplary configurations of a complementary read-out device and a complementary writing device of FIG. 10; and

FIG. 12 is a table showing an operation of a flag complementary device according to the fifth embodiment.

### DETAILED DESCRIPTION OF PREFERRED EMBODIMENT

Embodiments will be described below in detail with reference to the drawings as required. However, unnecessarily detailed description may be omitted. For example, detailed description of already Down matters and redundant description of substantially the same configuration may be omitted. All of such omissions are for facilitating understanding by those skilled in the art by preventing the following description from becoming unnecessarily redundant.

The inventor(s) provide the attached drawings and the following description for those skilled in the art to fully understand the present disclosure and does not intend to limit the subject described in the claims by the attached drawings and the following description.

### First Embodiment

To begin with, the first embodiment will be described.

<1. Configuration>

1-1. Memory Card (Storage Device)

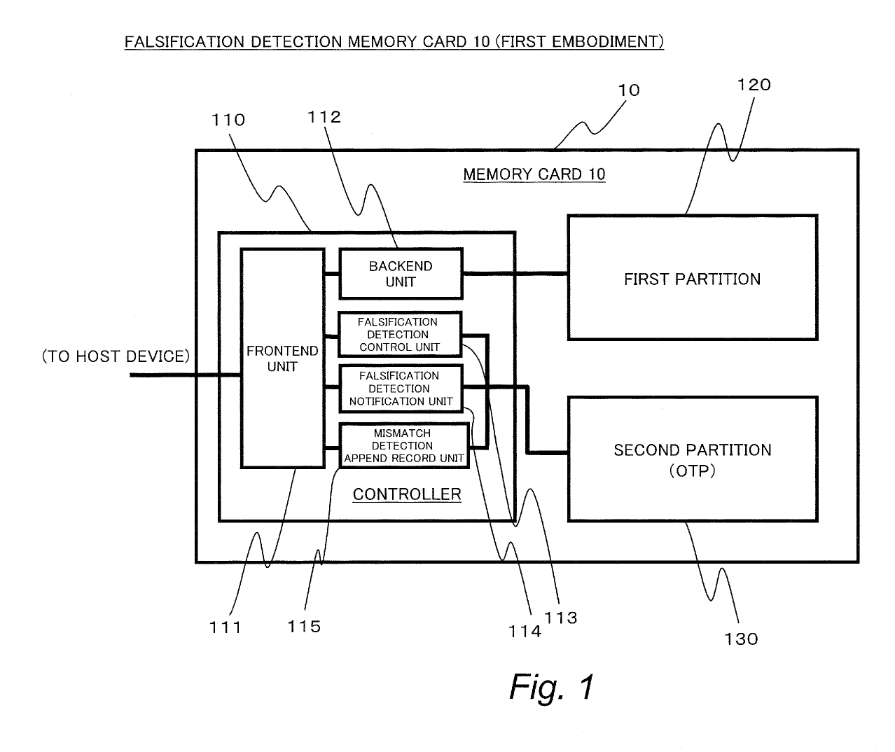

FIG. 1 illustrates a configuration of a memory card (storage device) 10 capable of falsification detection according to the first embodiment. As illustrated in the drawing, the falsification detection memory card 10 according to the first embodiment has a first partition 120, a second partition 130, and a controller 110.

In the first embodiment, the first partition (first storage area) 120 is made of a flash memory. Although not illustrated, the flash memory has a nonvolatile memory cells made of a plurality of flash memory elements arrayed in matrix. The first partition 120 stores file data such as image data captured by the user. The file data stored in the first partition 120 can be read out, erased, or subject to other operation performed by an external host device such as a DSC.

In the first embodiment, the second partition (second storage area) 130 is made of an OTP (one time program memory). The OTP refers to a memory which can be written only once. That is, the OTP can be written once, for example, from the state “0” to the state “1” bitwise. After that, it is impossible to write the OTP back from the state “1” to the state “0”. Meanwhile, the first partition 120 may be made of an LSI memory chip which is different from that of the second partition 130. The OTP may be made of the same memory chip as that of the first partition 120 or another flash memory chip without limited to the above described example. Further, the second partition 130 stores a numerical value for detecting whether the file stored in the first partition 120 is falsified or not, i.e., a calculated value for falsification detection (first calculated value for falsification detection). The calculated value for falsification detection is generated by calculating a fixed-length hash value from data in the file, for example. Details will be described later.

The controller 110 receives a command from the external host device, controls write/read of data, receives data, and sends the data to the host device. In addition, the controller 110 performs control associated with the calculated value for falsification detection and controls the first partition 120 and the second partition 130. The controller 110 has a frontend unit 111, a backend unit 112, a falsification detection control unit 113, a falsification detection notification unit 114, and mismatch detection append record unit 115.

The frontend unit 111 controls an interface with the external host device. The backend unit 112 controls the first partition 120. The falsification detection control unit 113 relates to the calculated value for falsification detection and controls the second partition 130. The falsification detection notification unit 114 determines, without reading out the calculated value for falsification detection (the first calculated value for falsification detection) which is stored in the second partition 130 to the outside of the memory card, whether a second calculated value for falsification detection provided from the external host device matches with the first calculated value for falsification detection and notifies the external host device of the determination result. When the determination result determined by the falsification detection notification unit 114 indicates mismatching, the mismatching detection append record unit 115 appends a record to the second partition 130 with the mismatched second calculated value for falsification detection. Details of the group of falsification detection functions 114, 115 of the above description will be described later.

1-2. Falsification Check DSC (Host Device)

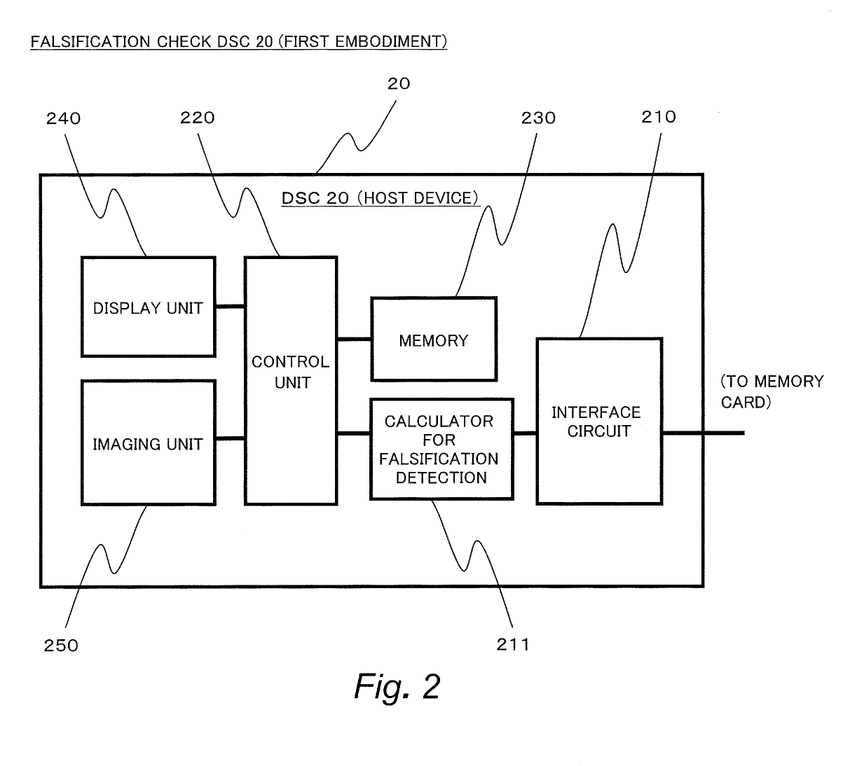

FIG. 2 is a diagram illustrating a structure of the DSC which provides falsification check for the memory card 10 of the present embodiment. The falsification check DSC 20 is the host device of the above described memory card 10. As illustrated in the drawing, the DSC 20 of the present embodiment has an interface circuit 210, a calculator for falsification detection 211, a control unit 220, a memory 230, a display unit 240, and a imaging unit 250.

The interface circuit 210 performs interface processing between the DSC 20 and the memory card 10. The calculator for falsification detection 211 calculates the value for falsification detection from data in an image file, which is captured with the imaging unit 250, by using a predetermined algorithm. The control unit 220 is made of a microcomputer which controls over the DSC 20. The memory 230 temporarily stores data of storage device for control, images, and the like. The display unit 240 displays a captured image and other various kinds of necessary information. The imaging unit 250 is responsible for taking images.

In the above described configuration, the image data and the like generated through photography in the imaging unit 250 are stored as file data into the first partition 120 via the backend unit 112 of the memory card 10 under the control of the control unit 220. That is, the DSC 20 is capable of storing the imaged file data into an external memory, i.e., the memory card 10.

The above described DSC 20 and memory card 10 are made into a recording system which is capable of checking presence or absence of falsification with a file. That is, in the first embodiment, when the DSC 20 is to store the imaged file data into the memory card 10, it calculates the value for falsification detection (the first calculated value) from data in a imaged file by using a predetermined algorithm with the calculator for falsification detection 211. When the data is to be written into the memory card 10, the control unit 220 issues a dedicated command and sends the calculated value for falsification detection to the memory card 10 together with the dedicated command.

From the received dedicated command, the memory card 10 recognizes that the calculated value for falsification detection is to be written into the second partition. Therefore, the received calculated value for falsification detection is stored in the second partition 130 via the frontend unit 111 and the falsification detection control unit 113. Detailed examples of the operation of storing the calculated value for falsification detection and the format of the calculated value for falsification detection to be stored will be described later. Incidentally, the imaged file data which is stored in the memory card 10 can be read out by a conventional DSC or personal computer as that stored in a conventional flash memory card.

1-3. Falsification Check Read-Out Device (Host Device)

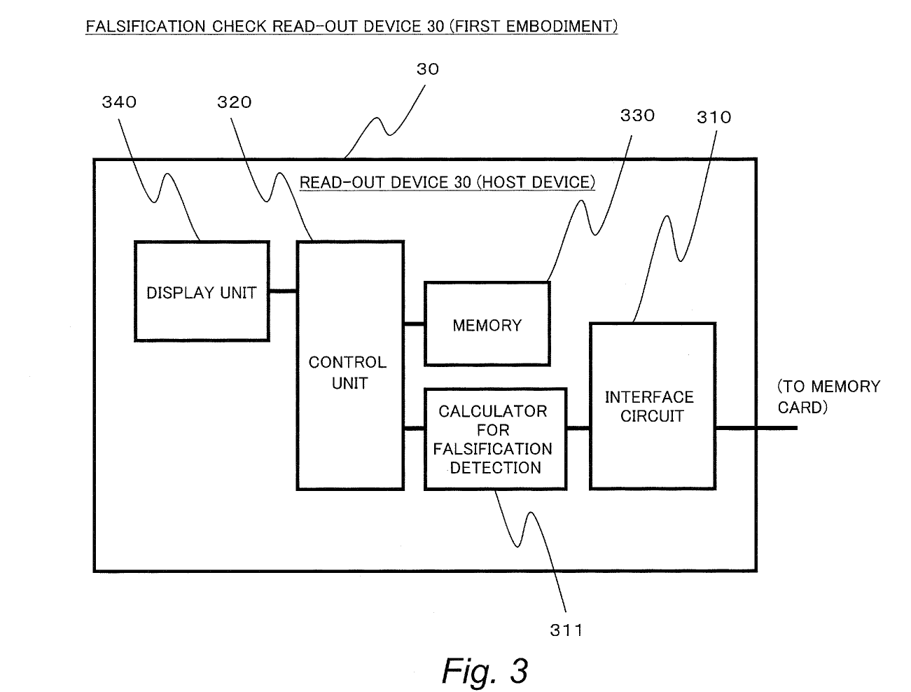

FIG. 3 illustrates a structure of the read-out device of the present embodiment. The illustrated falsification check read-out device 30 is the host device having a function of checking presence or absence of falsification with data stored in the memory card 10. Here, presence or absence of falsification can also be checked by the above described DSC 20, though, it may be checked by the read-out device 30 dedicated to check falsification illustrated in FIG. 3.

The read-out device 30 has an interface circuit 310, a calculator for falsification detection 311, a control unit 320, a memory 330, and a display unit 340. The read-out device 30 communicates with the above described memory card 10 by sending a command, data, and the like to the memory card 10 via the interface circuit 310. The calculator for falsification detection 311 calculates, by using a predetermined algorithm, the value for falsification detection from data in an imaged file, which is read out from the first partition 120 of the memory card 10 via the interface circuit 310. The control unit 320 is made of a microcomputer or the like and controls over the read-out device. The memory 330 temporarily stores a control program, image data, and the like. The display unit 340 displays an imaged image, other various kinds of necessary information, and the like. In place of the DSC 20, the read-out device 30 together with the memory card 10 makes a storage system which is capable of checking presence or absence of falsification with a file.

<2. System and Operation of Falsification Check>

Now, the system and operation of falsification check according to the first embodiment will be described. Here, a falsification check operation in a recording system which includes the DSC 20 and the memory card 10 will be described as an example.

2-1. System of Falsification Check (In Generating File Data)

The system of falsification check performed when file data is generated (when file data is written to the memory card 10) will be described. First, the file data to be checked for falsification is generated from the image data taken by the imaging unit 250 of the DSC 20. Then, the generated file data is transferred from the DSC 20 to the memory card 10, in which the file data is written to and stored in the first partition 120 via the backend unit 112.

When the DSC 20 writes the file data to the first partition 120 of the memory card 10, the file data passes through the calculator for falsification detection 211. The calculator for falsification detection 211 calculates the first value for falsification detection from the file data by using a predetermined algorithm. The obtained first calculated value for falsification detection is transferred from the DSC 20 to the memory card 10, in which the first calculated value for falsification detection is written to and stored in the second partition 130 via the falsification detection control unit 113. In that manner, the first calculated value for falsification detection is recorded in the memory card 10 together with the file data.

2-2. Falsification Check Operation (In Reading Out the File Data)

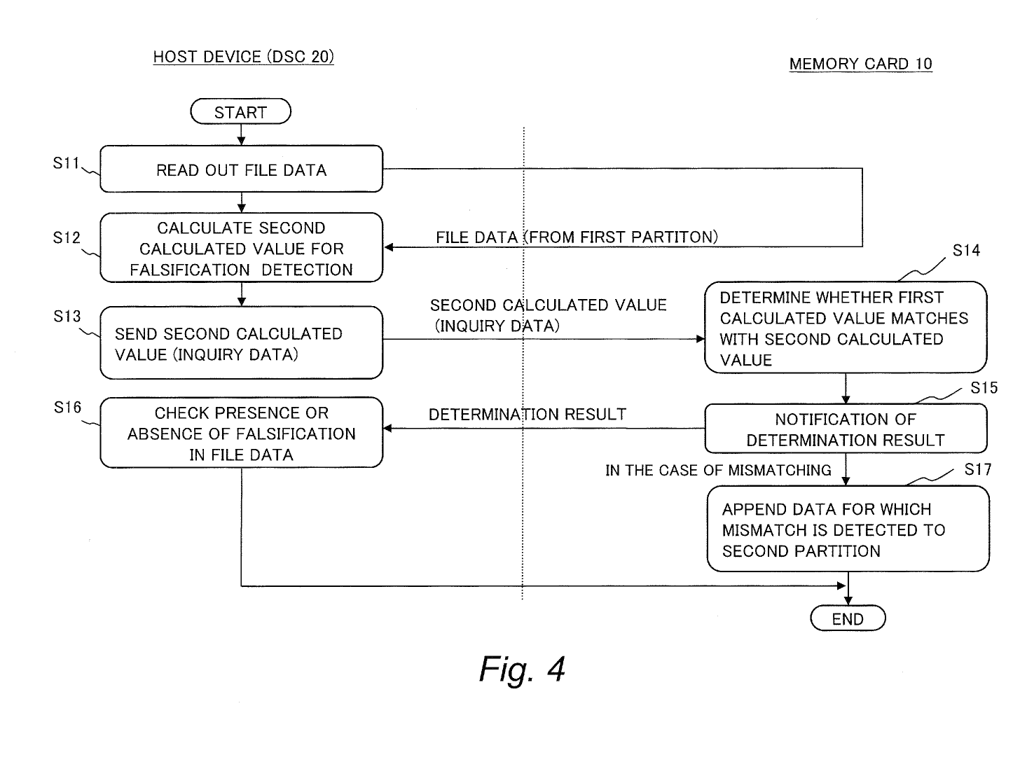

Now, the falsification check operation for checking presence or absence of falsification with the file data written to the memory card 10 performed in the above manner will be described with reference to FIG. 4.

(Step S11 (Reading Out of the File Data))

First, as described in FIG. 4, the control unit 220 of the DSC 20 reads out the file data stored in the first partition 120 of the memory card 10. The read out file data is temporarily held in the memory 230.

(Step S12 (Calculation of the Second Value for Falsification Detection))

Subsequently, the calculator for falsification detection 211 of the DSC 20 calculates the second value for falsification detection from the read out file data by using a predetermined algorithm. Meanwhile, the calculation to obtain the second calculated value for falsification detection may be performed by the calculator for falsification detection 211 while the file data is temporarily held in the memory 230.

(Step S13 (Sending Of Inquiry Data))

In order to check presence or absence of falsification, the control unit 220 of the DSC 20 sends the second calculated calculated value for falsification detection to the memory card 10 together with a command dedicated to falsification detection as inquiry data via the interface circuit 210.

(Step S14 (Determination of Whether the First Calculated Value for Falsification Detection Matches with the Second Calculated Value for Falsification Detection))

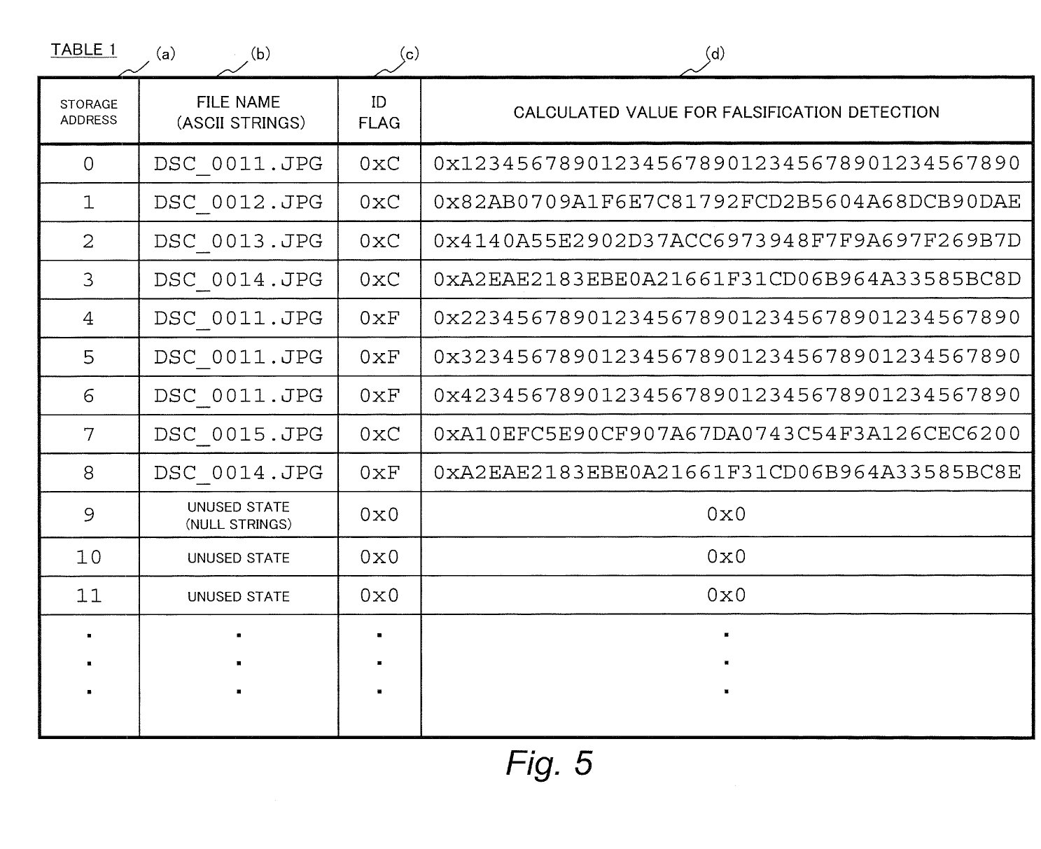

When the memory card 10 receives the command dedicated to falsification detection, the falsification detection notification unit 114 of the memory card 10 checks the first calculated value for falsification detection which is stored in the second partition 130 and managed by the file name against the second calculated value for falsification detection included in the inquiry data sent together with the file name. The determination will be specifically described later with reference to FIG. 5.

(Step S15 (Notification of the Determination Result))

The falsification detection notification unit 114 of the memory card 10 notifies the host device, i.e., the DSC 20 of the determination result checked in step S14.

(Step S16 (Use of the Determination Result))

Subsequently, the DSC 20 receives the determination result indicating match/mismatch which is notified from the memory card 10 and, according to the determination result, checks presence or absence of falsification in the file data.

(Step S17 (Append of a Record to the Second Partition with the Mismatch Detection Data))

Subsequently, when the result indicating mismatch is detected in the determination in step S14, the mismatch detection append record unit 115 appends a record to the second partition 130 with the mismatch detection data (identification flag (F)) as information indicating mismatch. Details will be specifically described later with reference to FIG. 5.

Incidentally, the operation of a storage system which includes the read-out device 30 illustrated in FIG. 3 and the memory card 10 is substantially the same as the above described operation. The only difference is that the read-out device 30 does not have the imaging unit 250 and a function of generating file data such as image data unlike the DSC 20. Therefore, the calculator for falsification detection 311 of the read-out device 30 is used only to calculate the second calculated value for falsification detection from the file data read out from the memory card 10 and does not calculate the first calculated value for falsification detection which would have been calculated at the generation of the file data.

Format of Information Stored in the Second Partition

Now, an exemplary format of information stored in the second partition 130 will be described with reference to FIG. 5. In Table 1 shown in FIG. 5, storage addresses (0, 1, 2, 3, . . . ) are stored in a field (a). File names (ASCII strings) are stored in a field (b). The identification flags (ID flags) are stored in a field (c). The calculated values for falsification detection are stored in a field (d). With the file name and the calculated value for falsification detection being stored in the fields (b) (d) in association with each other as described above, the imaged file data is associated with the calculated values for falsification detection.

Further, the identification flags corresponding to three states (1), (2), and (3) to be described below are stored in the field (c).

The state (1) is a state in which storage information is stored in the second partition 130 when the file is generated, i.e., when an image is taken. In that case, the code of the identification flag is set at “C” (“1100”), for example.

The state (2) is a state in which storage information is appended to the second partition 130 when the comparison made at the time of read out shows that the first calculated value for falsification detection mismates with the second calculated value for falsification detection. When the comparison made at the time of readout shows mismatch, the code of the identification flag is set at “F” (“1111”), for example. For example, as for the file name (DSC_{—}0011.JPG) which is the same as that in the storage address 0, the falsification detection notification unit 114 of the memory card 10 checks the first calculated value for falsification detection (0x123456 . . . ) which is stored in the second partition 130 against the obtained second calculated value for falsification detection (0x223456 . . . ) included in the inquiry data sent from the host device. As for the file name (DSC_{—}0011.JPG), the first calculated value mismatches the second calculated value as described above. Therefore, “F(0xF)” is appended to the storage address 4 as the state (2) of the identification flag for the file name (DSC_{—}0011.JPG)

The state (3) is a state in which the storage information is in the unused state. In the case of the unused state, the code of the identification flag is set at, for example, “0” (“0000”), i.e., the unwritten code (null strings) as the code of the identification flag for unwritten storage address.

Here, the second partition 130 is made of an OTP. Therefore, once the data is written, the stored data may not be rewritten or erased and data may only be appended. As a result, it becomes harder to falsify the data, and all of the stored data can be kept. For example, when the file name DSC_{—}0011.JPG is stored as the file data, the code of the identification flag is changed from “0” to “C” (“0000”→“1100”) and stored in the address 0 of the Table 1. Subsequently, in step S14, when it is determined that the calculated values mismatches each other as for the same file name DSC_{—}0011.JPG, the code of the identification flag is changed from “C(0xC)” to “F(0xF)” (“1100”→“1111”) and appended to the address 4. As such, with an OTP being used for the second partition 130, it is disabled to rewrite and erase the stored file data. For example, in the above case, the file data of the file name DSC_{—}0011.JPG at the addresses 4, 5, 6 to which “F” (“1111”) is appended as the code of the identification flag cannot be changed from “F” to “C” (“1111”→“1100”) as rewriting of the file code.

However, if data is appended to the second partition 130 for all of the file data, a huge capacity would be needed. Thereafter, the memory card 10 would not be used as a memory card for the falsification detection system and would only be used within a range of usual flash memory card, i.e., would only be used for storing file data into the first partition 120.

However, as it is also apparent from Table 1 shown in FIG. 5, the respective types of information stored in the second partition 130 according to the first embodiment are classified into respective types of information necessary for the respective fields (a) to (d) and stored. Therefore, the respective types of information to be stored in the second partition 130 can be stored by being compressed to around 32 bytes, for example, which is quite smaller than the image information which is approximately at least one million bytes. As a result, the memory size of the second partition 130 may be reduced to, for example, approximately at most one-thirty thousandths of the memory size of the first partition 120. Accordingly, even the second partition 130 made of an OTP device can store a sufficient number of photographed images. Further, the second partition 130 made of an OTP device can also store images taken in the case where the memory card is recycled with the old images erased (for example, 11 bytes for the file name, 1 byte for the identification flag, and 20 bytes for the calculated value for falsification detection).

A typical example of the first calculated value for falsification detection and the second calculated value for falsification detection is a hash value. The hash value is fixed-length data without regard to the data size. A typical example is a 160-bit hash value. The hash value can be used for not only such data as the very imaged file but also data including such information on date of generating the file and the size of the file. A typical hashing algorithm is SHA-1.

<3. Functional Effect>

With the configuration and the operation according to the first embodiment, at least the effect shown below can be obtained.

(1) Safe and Easy Falsification Detection Can be Provided Without Impairing the Intrinsic Advantage of Digitization.

As described above, the second partition (the second storage area) 130 according to the first embodiment allows data to be read out and data to be appended to an unwritten area and stores at least the first calculated value for falsification detection. Therefore, as it is apparent from Table 1 shown in FIG. 5, even in the case where the first calculated value for falsification detection is appended to the second partition 130, the respective types of information to be stored in the second partition 130 can be stored by being compressed to around 32 bytes, for example, which is quite smaller than the photograph information which is approximately at least one million bytes. As a result, the memory size of the second partition 130 may be reduced to, for example, approximately at most one-thirty thousandths of the memory size of the first partition (the first storage area) 120. Accordingly, even the second partition 130 made of an OTP device can store a sufficient number of photographed images, and does not impair the intrinsic advantage of digitization.

In addition, as it is apparent from the description of steps S14, S15 shown in FIG. 4, the falsification detection notification unit 114 according to the first embodiment never reads out the first calculated value for falsification detection which is stored in the second partition 130 and, for example, made of a hash value or the like to the host devices 20 and 30 which are outside the memory card 10. Further, the falsification detection notification unit 114 receives the second calculated value for falsification detection calculated from the file data by the host devices 20 and 30 together with the corresponding file name, then, determines whether the second calculated value for falsification detection matches the first calculated value for falsification detection, and notifies the external host devices 20 and 30 of the determination result.

As such, since the first calculated value for falsification detection itself which is, for example, made of a hash value or the like and needed to be used in a relatively high security environment for leakage prevention is not directly read out by the host devices 20 and 30 to be exposed to the outside of the memory card 10, falsification in file data can be safely detected. On the other hand, the host devices 20 and 30 can easily detect falsification in file data by checking the determination result notified from the memory card 10. Here, the host devices 20 and 30 can use the notified determination result as required (for example, to display a message indicating that the data may have been falsified).

### Second Embodiment

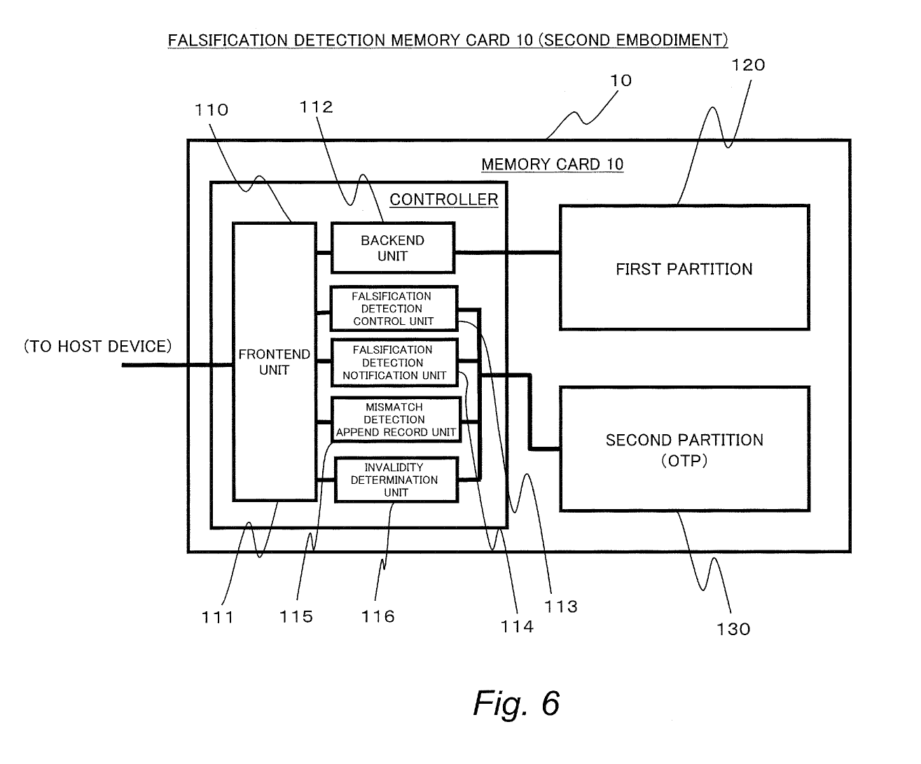

The second embodiment will be described with reference to FIG. 6. The description of the same part as that of the first embodiment will be omitted below.

<Configuration>

As illustrated in FIG. 6, the memory card 10 according to the second embodiment is different from that of the first embodiment in that the controller 110 further includes an invalidity determination unit 116. When the invalidity determination unit 116 notifies of falsification detection about a file (the above described step S15), it outputs determination of invalid to the external host devices 20 and 30 without regard to the content of the inquiry data.

<Falsification Check Operation>

The memory card 10 according to the second embodiment receives a command dedicated to falsification detection from the host devices, then, checks the first calculated value for falsification detection against the second calculated value for falsification detection, and when mismatch is detected, it causes the mismatch detection append record device 115 to append a record to the second partition 130 with mismatch detection data (step S17).

Further, in the second embodiment, when the number of mismatch for each file name exceeds a predetermined number of times, the mismatch detection append record unit 115 adds flag information indicating an invalid state (4), other than the above described states (1) to (3) to be stored as identification flags, to the field (c) and stores the information in the second partition 130. For example, when the predetermined threshold number of times is four and the number of mismatch for the file name DSC 0011. JPG exceeds the predetermined number of times, four, the mismatch detection append record unit 115 adds the flag information “A (0xA)” which indicates the state (4), i.e., the invalid state, to the field (c) and stores the information in the second partition 130 (not shown).

As a result, from that point forward in the falsification check operation, when the mismatch exceeds the predetermined threshold number of times in the event that the invalidity determination unit 116 responds to the command dedicated to falsification detection by notifying of the falsification detection about the corresponding file (the above described step S15), it outputs the determination of invalid to the external host devices without regard to the content of the inquiry data. The specific form of the memory card 10 of the second embodiment has been described above. Since the other parts of configuration and operation are practically the same as those of the first embodiment, a detailed description thereof is omitted.

<Functional Effect>

According to the second embodiment, at least the same effects as those of the first embodiment can be obtained. Further, in the memory card 10 according to the second embodiment, the controller 110 further includes the invalidity determination unit 116. Further, when the number of mismatch for each file name exceeds a predetermined number of times, the mismatch detection append record unit 115 adds the flag information indicating the invalid state as the state (4) to the field (c) and stores the information in the second partition 130. As a result, from that point forward in the falsification check operation, when the invalidity determination unit 116 responds to the command dedicated to falsification detection by notifying of the falsification detection about the corresponding file (the above described step S15), it outputs the determination of invalid to the external host devices 20 and 30 without regard to the content of the inquiry data.

Determination of invalid like that is effective in preventing conduct as shown below. For example, in the first place, a person falsifies file data (for example, falsifies image data, time stamp data, or the like), and the person still changes data in an area which does not affect the purpose of falsification (for example, data or the like in the area filled with meaningless data for the format of image data) on trial. Then, the person makes an inquiry at the memory card 10 with the second calculated value for falsification detection for the file data by several times to lead the memory card 10 to make trial until the second calculated value for falsification detection becomes the same as the first calculated value for falsification detection.

### Third Embodiment

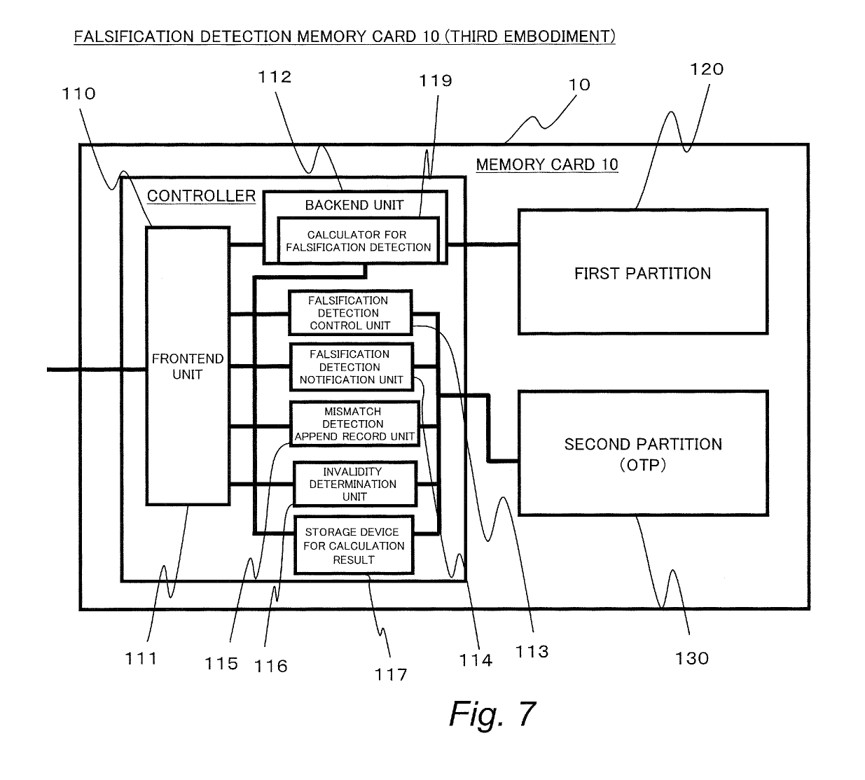

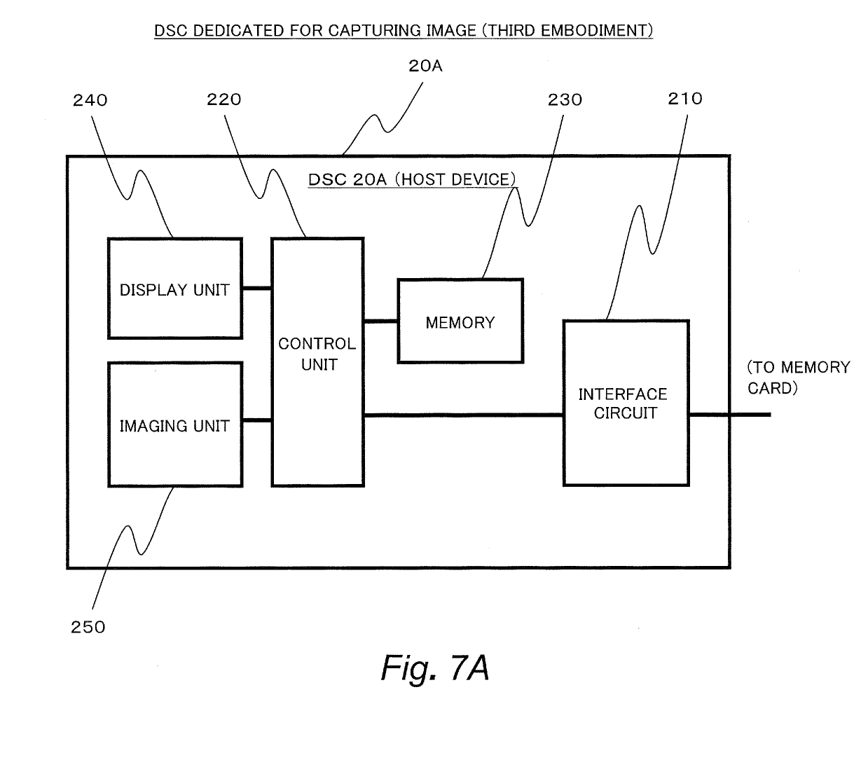

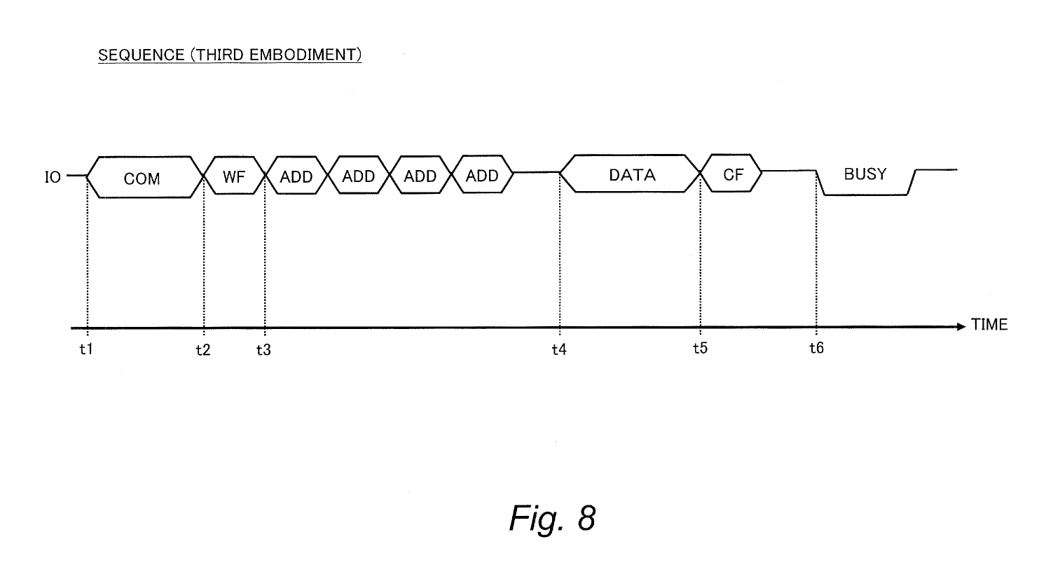

The third embodiment will be described with reference to FIG. 7, FIG. 7A, and FIG. 8. The description of the same part as that of the first embodiment will be omitted below.

<Configuration>

In the first embodiment and the second embodiment, the calculators for falsification detection 211, 311 for calculating the first calculated value for falsification detection and the second calculated value for falsification detection are provided for the host devices (the DSC 20, the read-out device 30). That is, when the imaged file data is stored into the memory card 10, the calculator for falsification detection 211 provided for the host device, i.e., the DSC 20, calculates the first calculated value for falsification detection as soon as the imaged file data is written into the memory card 10. Then, the control unit 220 issues a dedicated command and sends the first calculated value to the memory card 10. Alternatively, as soon as the host devices read out the imaged file from the memory card 10 for falsification check, the calculators for falsification detection 211 and 311 provided for the host devices calculate the second value for falsification detection, the control units 220 and 330 issue a dedicated command, and the second calculated value is sent to the memory card 10.

On the other hand, in the third embodiment, the calculator for falsification detection 119 and the store device for calculation 117 are provided for the memory card 10 as illustrated in FIG. 7. That kind of memory card 10 can be supported by a DSC dedicated for capturing image capable of falsification detection 20A as illustrated in FIG. 7A. Unlike the above described DSC 20, the DSC dedicated for capturing image capable of falsification detection 20A illustrated in FIG. 7A does not need the calculator for falsification detection 211 for calculating the first value when the file data is written. Here, the DSC dedicated for capturing image capable of falsification detection 20A is a host device that does not perform falsification detection on file data during reproduction of an image, which is a form of DSC for functioning as an apparatus dedicated for capturing image capable of falsification detection. Therefore, as described later, the DSC dedicated for capturing image capable of falsification detection 20A issues specialized START command and QUIT command to the memory card 10 instead of notifying the memory card 10 of the first calculated value for falsification detection.

The calculator for falsification detection 119 illustrated in FIG. 7, which is placed in the backend unit 112, receives via the frontend unit 111 the START command and the QUIT command related to the specialized calculated value for falsification detection issued by the DSC dedicated for capturing image capable of falsification detection 20A and calculates the first calculated value for falsification detection from data received during the period between the reception of the START command and the QUIT command. The storage device for calculation 117 stores the first calculated value for falsification detection calculated by the calculator for falsification detection 119 in the second partition 130. Further, the storage device for calculation 117 stores the second calculated value for falsification detection calculated by the calculator for falsification detection 119 in step S17 in the second partition 130 only on the condition that mismatch is notified in step S15. As such, in the third embodiment, since the memory card 10 is provided with the calculator for falsification detection 119, the host device (the DSC dedicated for capturing image capable of falsification detection 20A illustrated in FIG. 7A) does not need to notify the memory card 10 of the first calculated value when it writes data to the memory card 10. Incidentally, the read-out device 30 is used for the falsification check on the file data which is imaged by the DSC dedicated for capturing image capable of falsification detection 20A.

<Falsification Check Operation>

Now, the falsification check operation according to the third embodiment will be described. First, as in the first embodiment, file data generated by the imaging unit 250 of DSC dedicated for capturing image capable of falsification detection 20A is transferred from the DSC 20 to the memory card 10, in which the file data is written to and stored in the first partition 120 via the backend unit 112. Further, in the third embodiment, the transferred file data passes through the calculator for falsification detection 119. The calculator for falsification detection 119 calculates the first calculated value for falsification detection from the file data by using a predetermined algorithm. Then, the obtained first calculated value for falsification detection is sent from the calculator for falsification detection 119 to the storage device for calculation 117. The store device for calculation 117 writes the first calculated value for falsification detection to the second partition 130 to be stored.

At that moment, as illustrated in FIG. 8, when the host device, i.e., the DSC dedicated for capturing image capable of falsification detection 20A, writes file data to the memory card 10, it issues specialized START command, WRITE command, address, data, and QUIT command sequentially to the memory card 10 without notifying the memory card 10 of the first calculated value for falsification detection. As illustrated in FIG. 8, at time t1, the host device, i.e., the DSC dedicated for capturing image capable of falsification detection 20A, issues the specialized START command (COM) which is related to the calculation for falsification detection while the memory card 10 is in the ready state. In response to that command, the calculator for falsification detection 119 of the memory card 10 proceeds to the calculation of the first calculated value for falsification detection.

Subsequently, at time t2, the host device, i.e., the DSC DSC dedicated for capturing image capable of falsification detection 20A, issues the WRITE command (WF) to the memory card 10. At time t3, the host device, i.e., the DSC specialized in falsification detecting photography 20A, sends the address (ADD) of the read out file data to the memory card 10. At time t4, the host device, i.e., the DSC dedicated for capturing image capable of falsification detection 20A, sends the file data stored at the address to the memory card 10. At time t5, the host device, i.e., the DSC dedicated for capturing image capable of falsification detection 20A, issues the QUIT command (CF) to the memory card 10. At time t6, the memory card 10 enters a busy state (BUSY) to perform the operation below.

On the other hand, the second calculated value for falsification detection is notified from the memory card 10 to the host device, i.e., the read-out device 30, via the backend unit 112 in response to another specialized command (not shown) issued by the host device, i.e., the read-out device 30. As a result, the host device, i.e., the read-out device 30 is enabled to perform falsification check after it performed the same operation as that of the above described step S13 and after. Since the other parts of configuration and operation are practically the same as those of the first embodiment, a detailed description thereof is omitted.

<Functional Effect>

According to the third embodiment, at least the same effects as those of the first embodiment can be obtained. Further, in the third embodiment, the host device, i.e., the DSC specialized in falsification detecting photography 20A, does not need the calculator for falsification detection 211, and the memory card 10 has the calculator for falsification detection 119 and the storage device for calculation 117. As a result, the calculator for falsification detection 211 of the host device, i.e., the DSC dedicated for capturing image capable of falsification detection 20A, becomes unnecessary, which advantageously alleviates the operating load of the host device, i.e., the DSC dedicated for capturing image capable of falsification detection 20A. For that purpose, the third embodiment can be applied as required. Also, it is needless to say that the host device includes the calculator for falsification detection 211 as necessary.

As such, the DSC dedicated for capturing image capable of falsification detection 20A does not have the calculator for falsification detection 211, therefore, it does not need to notify the memory card 10 of the first calculated value for falsification detection when it generates imaged file data, because it is considered that usually the very photographer of the image data reproduces the image data immediately after taking the image for confirmation, thus, it is almost needless to suspect the photographer to falsify the data. Therefore, with the system which includes the memory card 10 and the DSC dedicated for capturing image capable of falsification detection 20A according to the third embodiment, the DSC dedicated for capturing image capable of falsification detection 20A can be implemented with almost the same configuration and manufacturing cost as those of the conventional DSC. The read-out device 30 may be used as described above to perform the falsification check.

### Fourth Embodiment

The fourth embodiment will be described. The description of the same part as that of the third embodiment will be omitted below.

<Configuration>

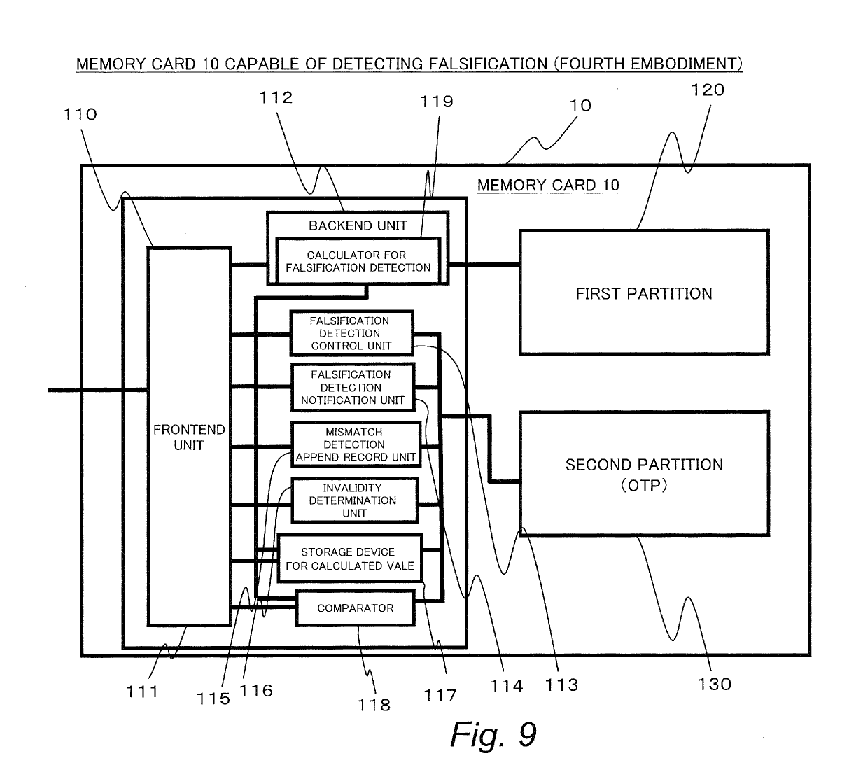

As illustrated in FIG. 9, the fourth embodiment differs from the third embodiment in that the controller 110 of the memory card 10 further includes a comparator 118. The comparator 118 compares the first calculated value for falsification detection which is calculated by the calculator for falsification detection 119 and stored in the second partition when the file data is generated with the second calculated value for falsification detection which is calculated by the calculator for falsification detection 119 when the file data is read out, and notifies the host device of the comparison result.

<Falsification Check Operation>

The falsification check operation according to the fourth embodiment is such that when the host device reads out the imaged file from the first partition 120 of the memory card 10 (S11), it issues the specialized START command and QUIT command for the readout file and notifies the memory card 10 of them (S13). The sequence is the same as that described in the FIG. 8. That is, as described in FIG. 8, the host device issues a specialized START command related to the calculation for falsification detection to be performed upon reading out of the file, and in response to that command, the calculator for falsification detection 119 of the memory card 10 proceeds to the calculation of the second calculated value for falsification detection. Subsequently, at time t2, the host device issues a READ command to the memory card 10, and proceeds to the following operation which is the same as that of writing the file data to the memory card 10. Unlike the third embodiment, however, the WRITE command (WF) described in FIG. 8 is replaced with the READ command, and the direction of data (DATA) is reversed, i.e., data is output from the memory card 10 instead of being input to the memory card 10. Then, the host devices 20 and 30 are enabled to perform falsification check after they performed the same operation as that of the above described step S13 and after (though, the second calculated value for falsification detection is not sent in step S13). As a result, the memory card 10 can obtain the second calculated value for falsification detection without having the host devices 20 and 30 send the second calculated value for falsification detection.

Subsequently, the comparator 118 compares the first calculated value for falsification detection stored in the second partition 130 against the second calculated value for falsification detection stored in the second partition 130 and notifies the host device such as the DSC 20 or the read-out device 30 of the comparison result. Here, the comparison result notified by the comparator 118 to the host device is the determined result alone and does not include the hash value and the like including information on date of generating the file and the size of the file, for example. That can further improve confidentiality. As described above, according to the fourth embodiment, the host devices of the DSC 20 and the read-out device 30 do not need the calculators for falsification detection 211 and 311. Since the other parts of configuration and operation are practically the same as those of the third embodiment, a detailed description thereof is omitted.

<Functional Effect>

According to the fourth embodiment, at least the same effects as those of the first embodiment can be obtained. Further, in the fourth embodiment, the comparator 118 compares the first calculated value for falsification detection stored in the second partition 130 against the second calculated value for falsification detection stored in the second partition 130 and notifies the host device of the comparison result. As such, according to the fourth embodiment, the comparison result notified by the comparator 118 to the host device is the determined result alone, and the hash value and the like including information on date of generating the file, for example, are not notified to the external host device. Therefore, according to the fourth embodiment, the memory card 10 is not required to receive the first calculated value and the second calculated value which are made of the hash value and the like from the host devices 20 and 30. That is, in the fourth embodiment, the first calculated value and the second calculated value are not exposed on the bus of the interface between the memory card 10 and the host devices 20 and 30, which can further improve confidentiality than conventional art.

### Fifth Embodiment (Complementary Second Partition)

Now, the fifth embodiment will be described. The fifth embodiment relates to an example in which the second partitions 130 complement each other (complementary). The description of the same part as that of the first embodiment will be omitted below.

<Configuration>

Here, as described above, the second partition 130 made of an OTP device for storing the calculated value for falsification detection cannot allow information which has been written bitwise to be rewritten to recover the original state or to be erased to reset the current state as a flash memory does, due to its nature of OTP. However, when the second partition is configured to represent binary number by combinations of a written bit and an unwritten bit, the state of the second partition can be changed after the unwritten bit alone is additionally written. In the case of an OTP which stores a value “0101” in binary number, i.e., “5” in decimal number (it is assumed that an unwritten bit is “0” and a written bit is “1”, for example), by additionally writing in only the bit of the second “0”, the value can be changed to “0111” in binary number, i.e., “7” in decimal number. To address that matter, the fifth embodiment proposes prevention of such bitwise falsification.

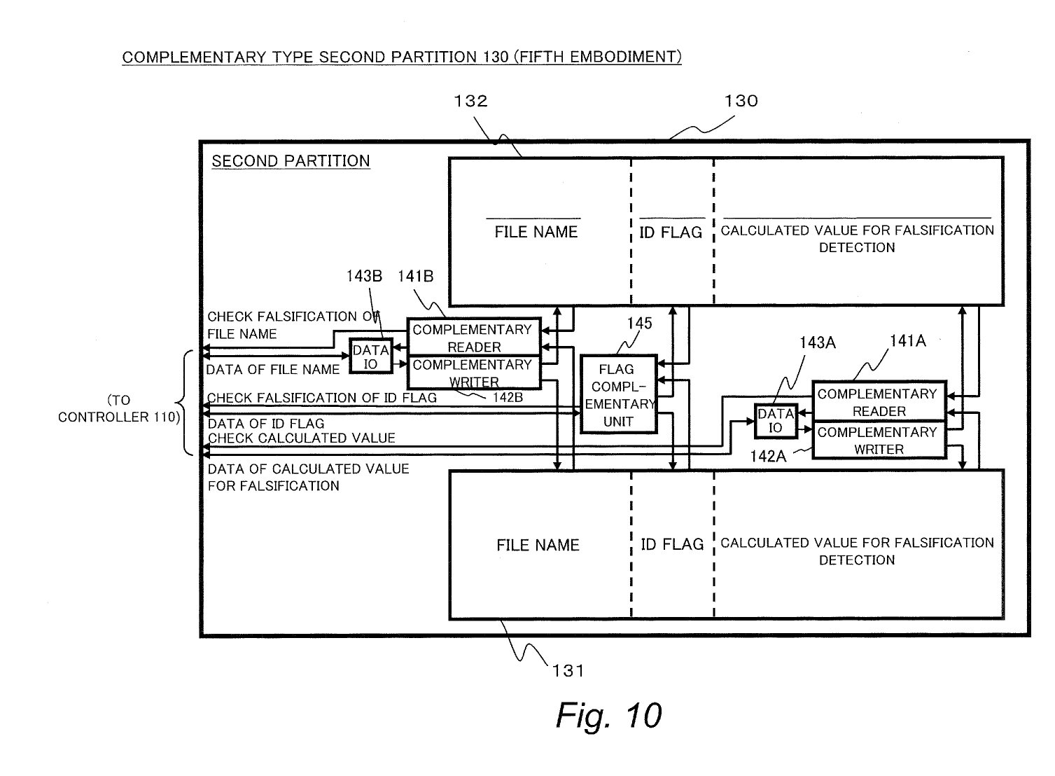

As illustrated in FIG. 10, the fifth embodiment is different from the first embodiment in that the second partition 130 is made of two complementary second partitions 131, 132 (OTP1, OTP2). As such, in the fifth embodiment, the memory of the second partition 130 is divided into a memory 1 of the second partition (hereinafter, it may be referred to as “OTP1”) and a memory 2 of the second partition (hereinafter, it may be referred to as ‘OTP2’).

The OTP1 stores the file name, the identification flag information, and the calculated value for falsification detection of the fields (b) to (d) shown in Table 1 of FIG. 5. On the other hand, the OTP2 stores the reverse values of the file name, the identification flag information, and the calculated value for falsification detection. As such, the OTP1 and the OTP2 store data complementary to each other. The data stored in the OTP1 and the OTP2 can be read out via complementary reader 141A, 141B and easily checked whether the data has been falsified. As will be described later, the complementary reader 141A, 141B can be easily implemented by simply performing an exclusive or on each bit.

Further, the data is written into the OTP1 and the OTP2 via complementary writer 142A, 142B. The complementary writer 142A writes the calculated value for falsification detection which is input via a data IO 143A into the OTP1 and the OTP2, respectively. The complementary writer 142B performs data writing on the file name data which is input via a data IO 143B into the OTP1 and the OTP2, respectively. As will be described later, the complementary writer 142A, 142B can be easily implemented by providing a simple logic for each bit. Since it is needed to change the state of the identification flag as required, a flag complementary unit 145 is used for slightly different operations. The operations of the flag complementary device 145 will be described later with reference to Table 2.

### Exemplary Configurations of the Complementary Reader 141A, the Complementary Writer 142A

Configurations of the complementary read-out device 141A and the complementary writing device 142A

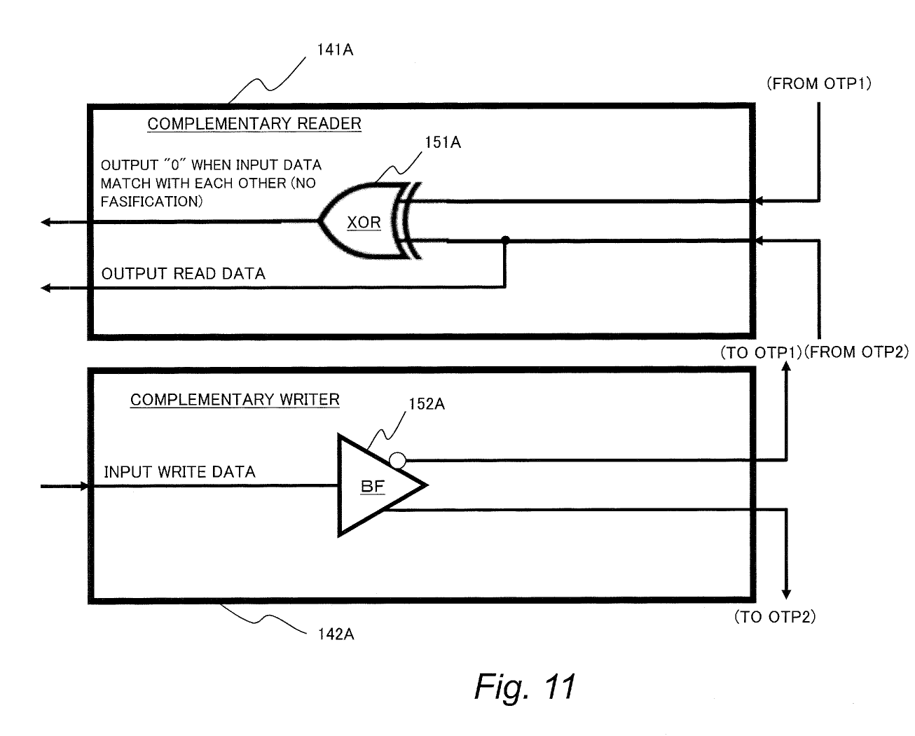

Now, exemplary configurations of the complementary reader and the complementary writer will be described with reference to FIG. 11. Here, the complementary reader 141A and the complementary writer 142A will be described as an example.

As shown in FIG. 11, the complementary reader 141A is made of an exclusive-or circuit 151A. The calculated value for falsification detection and the reverse data of the calculated value for falsification detection from the OTP1 and the OTP2 are supplied to the inputs of the exclusive-or circuit 151A, and the result of the exclusive-or operation is output from the exclusive-or circuit 151A. Therefore, when the input data match each other (data has not been falsified), “0” is output. Also, the data read out from the OTP2 is output to the controller 110 as an output of the result of falsification.

The complementary writer 142A is made of a buffer circuit 152A. From the writing data which is input, the buffer circuit 152A writes the calculated value for falsification detection to the OTP1 and writes the reversed calculated value for falsification detection to the OTP2.

<Falsification Check Operation>

In the above described configuration, the falsification check operation according to the fifth embodiment differs from that of the first embodiment in that complementary data of the file name, the identification flag, and the calculated value for falsification detection is used in determining match/mismatch of the first calculated value for falsification detection and the second calculated value for falsification detection in step S14 described in FIG. 4. For example, complementary data which is read out from the OTP1 and the OTP2 by the complementary reader 141A is used for the calculated values for falsification detection. Complementary data which is read out from the OTP1 and the OTP2 by the complementary reader 141B is used for the file name. Complementary data which is read out from the OTP1 and the OTP2 by the flag complementary unit 145 is used for the identification flag. The operations of the flag complementary unit 145 will be described in detail below with respect to the identification flag.

Operations of the Flag Complementary unit 145

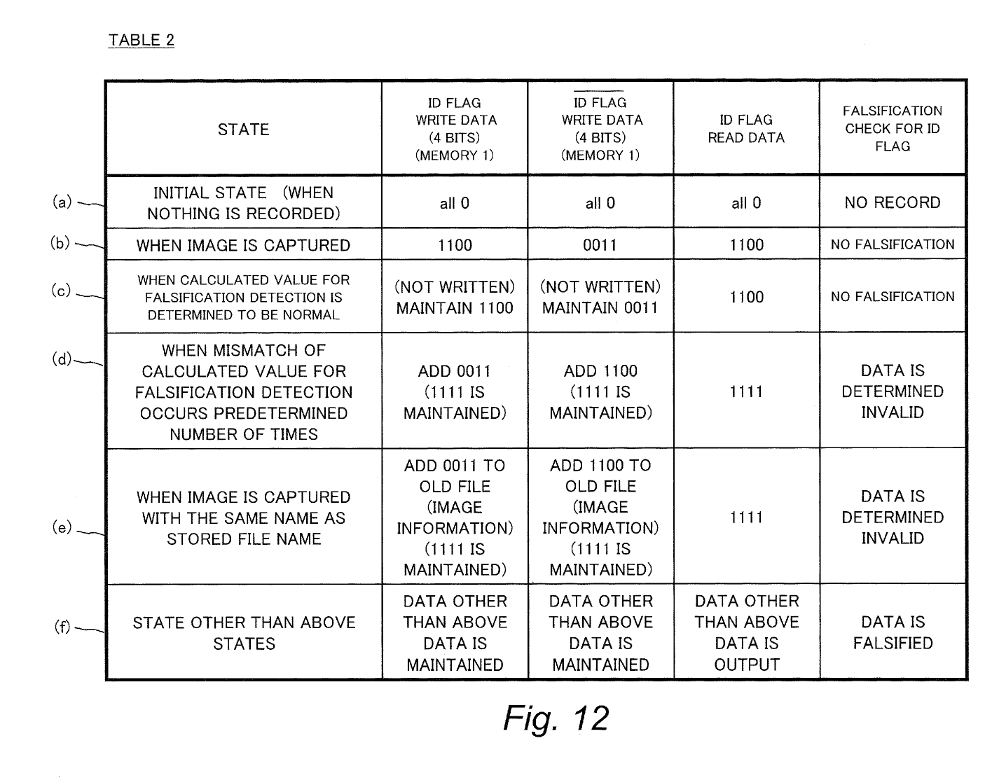

Now, the operations of the flag complementary unit 145 will be described with reference to Table 2 shown in FIG. 12.

As described in FIG. 12(a), when nothing is recorded at first in the initial state, all of the four bits are “0” (all 0) in both of the OTP1 and the OTP2. Therefore, the host device or the like which has performed a read out operation in that state can recognize that the corresponding data has not been stored yet in the memory card 10. As described in FIG. 12(b), when imaged file data is generated, in response to a command from the host device such as the DSC 20 or the like, data “1100” in binary number is stored in the OTP1 and the complementary data “0011” is stored in the OTP2.

Next, as described in FIG. 12(c), as a result of reading out of the first calculated value for falsification detection and the second calculated value for falsification detection in step S14 for the purpose of checking that the stored image is not falsified, when the data match each other, thus, when it is determined that the file data is not falsified, the data is only read out from the OTP1 and the OTP2. As a result, since the data is not written, the data is not changed (the state of the data is maintained). On the other hand, as described in FIG. 12(d), as a result of reading out of the first calculated value for falsification detection and the second calculated value for falsification detection in step S14, when the data mismatch, thus, when it is determined abnormal, the identification flag itself is added bitwise to store the trouble of calculating every time so that the state of the data is changed (S17). Specifically, “0011” is added to the OTP1 and “1100” is complementally added to the OTP2. Since “1” cannot be written back to “0” due to the nature of OTP, the data “1111” is held in both of the OTP1 and the OTP2. Therefore, from that point forward, when the host device reads out the stored address, it can recognize invalidity of the stored address data by confirming “1111” of the read out identification flag data.

As described in FIG. 12(e), since “0011” is added to the OTP1 and “1100” is added to the OTP2 also when the device determines that there is a kind of falsification, the stored address data can be nullified (“1111” is maintained). As described in FIG. 12(f), since data other than those described above is maintained when the data of the OTP1 and the data of the OTP2 are other than the above described data, the flag complementary unit 145 can determine that there is falsification.

<Functional Effect>

According to the fifth embodiment, at least the same effect as the above described (1) can be obtained. Further, in the fifth embodiment, the second partition 130 is made of two complementary second partitions 131, 132 (OTP1, OTP2). Therefore, even if the second partition 130 is falsified directly from outside, the falsification can be easily detected by using data read out from the two complementary second partitions 131, 132 (OTP1, OTP2). Consequently, the embodiment is advantageous in that it can improve the accuracy of security and can construct a highly reliable system.

### Other Embodiments

The first to fifth embodiments have been described as an example in which the second partition 130 is made of OTP(s). However, as described above, it is also possible to use a flash memory so that the falsification detection control unit 113 controls the second partition 130 to be neither rewritten nor erased and causes the second partition 130 to provide the same function as that of the described embodiments. Although imaged file data has been exemplified in the above described embodiments, the data is not limited to the imaged file data. For example, the embodiments may be applied to the general other types of file data such as video data. However, as for the case where the memory card 10 calculates the value for falsification detection inside itself in response to the specialized START command and QUIT command as described in the third embodiment and the fourth embodiment, it is assumed that writing and reading of a file is continuously performed for one file. Therefore, in the case of a recording system in which a plurality of files are opened to be randomly written or read out, the present invention does not suit the intention of the system.

As described above, since the first to fifth embodiments not only allow to capture an image and erase an unnecessary file as the conventional DSC does but also easily check that an imaged file is not falsified, the embodiments can further improve the reliability.

The first to fifth embodiments have been described above as examples of the technology of the present disclosure. For those purposes, the accompanying drawings and the detailed description have been provided. Therefore, the constituent elements shown or described in the accompanying drawings and the detailed description may include not only the constituent element necessary to solve the problem but also the constituent element unnecessary to solve the problem for the purpose of exemplifying the above described technology. Accordingly, it should not be instantly understood that these unnecessary constituent element is necessary since these unnecessary constituent element is shown or described in the accompanying drawings and the detailed description.

Since the above described embodiments are for exemplifying the technology in the present disclosure, the embodiments may be subject to various kinds of modification, substitution, addition, and omission without departing from the scope of the claims and their equivalents.

### INDUSTRIAL APPLICABILITY

The present disclosure can be applied to an application and the like in the field in which it is required to ensure that a file recorded in a memory card, a recording system, or the like, for example, is not falsified.

What is claimed is:

1. A storage device comprising:
a first storage area in which data can be read out and rewritten and file data is stored;
a second storage area in which data can be read out and appended to an unwritten area and a first calculated value for detecting falsification which is calculated from the file data; and
a controller that performs access control on the first storage area and the second storage area, wherein
the controller comprises:
a frontend unit that receives a command from an external host device and accesses the first storage area and the second storage area; and
a falsification detection notification unit that determines, without reading out the first calculated value to the host device, whether the first calculated value matches a second calculated value for detecting falsification which is calculated from the file data and notifies the host device of the determination result.

2. The storage device according to claim 1 wherein the controller comprises an append record unit which appends the second calculated value which indicates mismatch to the second storage area, when the determination result indicates the mismatch.

3. The storage device according to claim 2 wherein the controller comprises an invalidity determining unit which outputs an error to the host device and afterword, outputs determination of invalidity without regard to content of a command from the host device, when the second calculated value which indicates mismatch is appended to the second storage area by the append record unit no less than predetermined number of times.

4. The storage device according to claim 1 wherein the controller comprises:
a calculating unit that calculates the first calculated value from file data between START command and QUIT command provided from the host device; and
a storage unit that stores the first calculated value into the second storage area.

5. The storage device according to claim 4 wherein the controller further comprises a comparing unit that compares the first calculated value with the second calculated value to determine whether the values match with each other and notifies the comparison result to the host device.

6. The storage device according to claim 1 wherein the second storage area is configured to two memories which store data complementary to each other.

7. A host device which is to be connected with a storage device comprising a first storage area in which data can be read out and rewritten and file data is stored, a second storage area in which data can be read out and appended to an unwritten area, and a controller that performs access control on the first storage area and the second storage area, the host device comprising:
a calculating unit which calculates a first calculated value and a second calculated value for detecting falsification; and a control unit which controls the calculating unit,
wherein the calculating unit calculates the first calculated value from file data when the file data is stored in the first storage area,
the control unit sends the first calculated value to the storage device, the sent first calculated value being stored in the second storage area,
the calculating unit calculates the second calculated value from file data when the file data is read out from the first storage area, and
the control unit sends the second calculated value to the storage device as inquiry data and receives a determination result determined by the storage device on whether the first calculated value matches with the second calculated value.

8. A storage system comprising:
a storage device comprising: a first storage area in which data can be read out and rewritten and file data is stored; a second storage area in which data can be read out and appended to an unwritten area and a first calculated value for detecting falsification which is calculated from the file data; and a controller that performs access control on the first storage area and the second storage area, and
a host device comprising: a calculating unit which calculates a first calculated value and a second calculated value for detecting falsification; and a control unit which controls the calculating unit, wherein
the calculating unit calculates the first calculated value from file data when the file data is stored in the first storage area,
the control unit sends the first calculated value to the storage device,
the sent first calculated value is stored in the second storage area,
the calculating unit calculates the second calculated value from file data when the file data is read out from the first storage area, and
the control unit sends the second calculated value to the storage device as inquiry data and receives a determination result determined by the storage device on whether the first calculated value matches with the second calculated value.
